(19) United States
(12) Patent Application Publication
(10) Pub. No.: US 2006/0246951 A1
(43) Pub. Date: Nov. 2, 2006

(54) Wireless intelligent network custom call routing for integrating enterprise networks with mobility networks

(76) Inventors: Robert T. Calabrese, Naperville, IL (US); Martin C. Smith, Swindon (GB)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/120,011

(22) Filed: May 2, 2005

(51) Int. Cl. H04Q 7/20; H04M 1/00

(52) U.S. Cl. 455/560

(57) ABSTRACT

A method in one example is directed to utilizing a WIN (wireless intelligent network) and a SCP (service control point) to intelligently route mobile originated calls destined for a private network, from current serving MSC (mobile switching center) to a designated gateway MSC.

### TECHNICAL FIELD

The invention relates generally to telecommunication networks, and more particularly to integration of a private network with a mobility network.

### BACKGROUND

Mobile Service providers are currently looking for a way to integrate the private network of an enterprise customer into the mobility network. Typically, when enterprise customers enter the mobility network, they lose the ability to utilize their private network's dedicated facilities, least cost routing schemes, and PSTN (Public Switched Telephone Network) bypass capabilities. The enterprise customer must rely on the PSTN to deliver local, long distance and international calls to its private network.

Mobile service providers could provide this service to their enterprise customers by providing access to dedicated facilities within the mobility network. In order to achieve a nation wide solution, the mobile service provider would have to have interconnectivity between all of its Mobile Switching Centers (MSC) within a given country. This is not always the case. Some service providers have interconnectivity within a certain market but rely on the PSTN facilities to deliver calls between markets. In addition the mobile service provider would have to maintain custom dialing plans and routing for each enterprise customer on every MSC.

Thus there is a need in the art to be able to intelligently route mobile originated calls destined for a private network, from a current serving MSC to a designated gateway MSC.

### SUMMARY

The invention in one implementation encompasses an apparatus. The apparatus may comprise a WIN (wireless intelligent network) operatively coupled to a SCP (service control point) to intelligently route mobile originated calls destined for a private network, from a current serving MSC (mobile switching center) to a designated gateway MSC.

An implementation of the invention encompasses a method. This method may comprise: method in one example is directed to utilizing a WIN (wireless intelligent network) and a SCP (service control point) to intelligently route mobile originated calls destined for a private network, from current serving MSC (mobile switching center) to a designated gateway MSC.

Another implementation of the invention encompasses a method. This method may comprise: dialing an international access number from a mobile terminal, the access number being received by a serving MSC (mobile switching center); launching a trigger from the serving MSC to a SCP based application; determining, at the SCP based application, from the trigger that the destination is international and returning a TRN (temporary routing number) to the serving MSC; sending the TRN from the serving MSC to a gateway MSC via a PSTN (public switched telephone network); sending, from the gateway MSC, a SCPDS (specific called party digit string) trigger to a SCP (service control point) in the gateway MSC; determining, at the SCP, that the received SCPDS trigger is a special SCPDS trigger and performing a table look up on a CPN (calling party number), the SCP making an internal association with the CPN and dialed digits of the international access number; and returning one of the original dialed digits or translated digits based on the original digits, when the SCP finds a match for the CPN; and routing, by the gateway MSC, the original dialed digits to a PBX (private branch exchange) via PRI (primary rate interface).

### DESCRIPTION OF THE DRAWINGS

Features of exemplary implementations of the invention will become apparent from the description, the claims, and the accompanying drawings in which:

FIG. 1 is a representation of one implementation of a single gateway MSC architecture;

FIG. 2 is a representation of one implementation of a regional gateway MSC architecture;

FIG. 3 is a representation of one exemplary flow diagram for integrating a private network with a mobility network; and

FIG. 4 is another representation of one exemplary flow diagram for integrating a private network with a mobility network.

### DETAILED DESCRIPTION

Embodiments of the present apparatus and method utilize a wireless intelligent network (WIN) and a service control point (SCP) to intelligently route mobile originated calls destined for a private network, from a current serving MSC to a designated gateway MSC. The designated gateway MSC may have direct connect trunking facilities to the enterprise customer's private network.

After receiving a call from a serving MSC, the gateway MSC may then route the call directly to the private network. The private network may carry the call to its final destination within the private network (local, long distance, or international). Routing from the current serving MSC to the designated gateway MSC may be over dedicated facilities, via the PSTN, via Internet protocol facilities, etc.

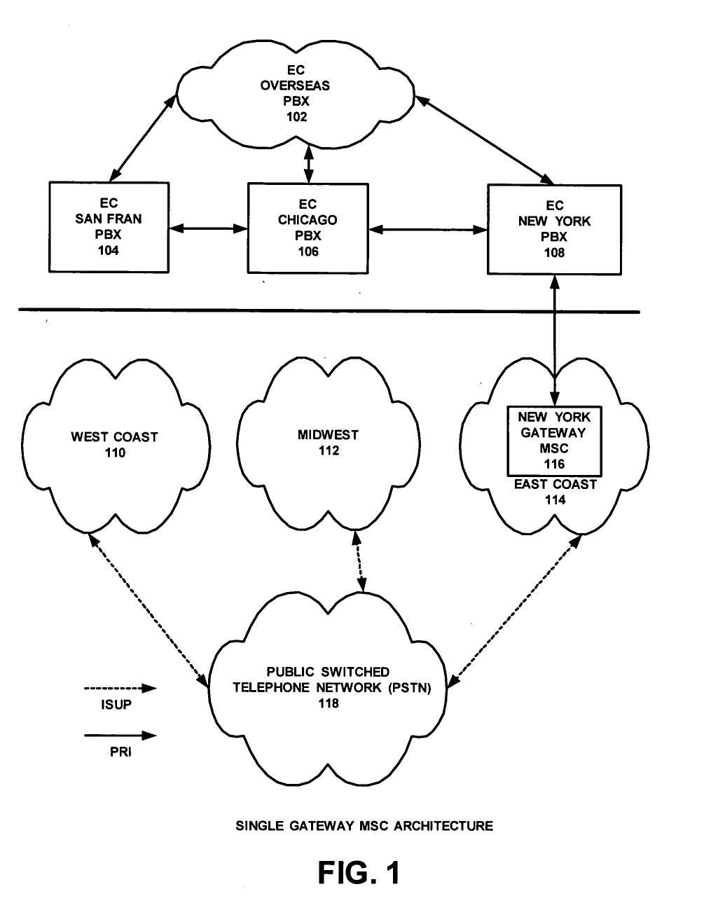

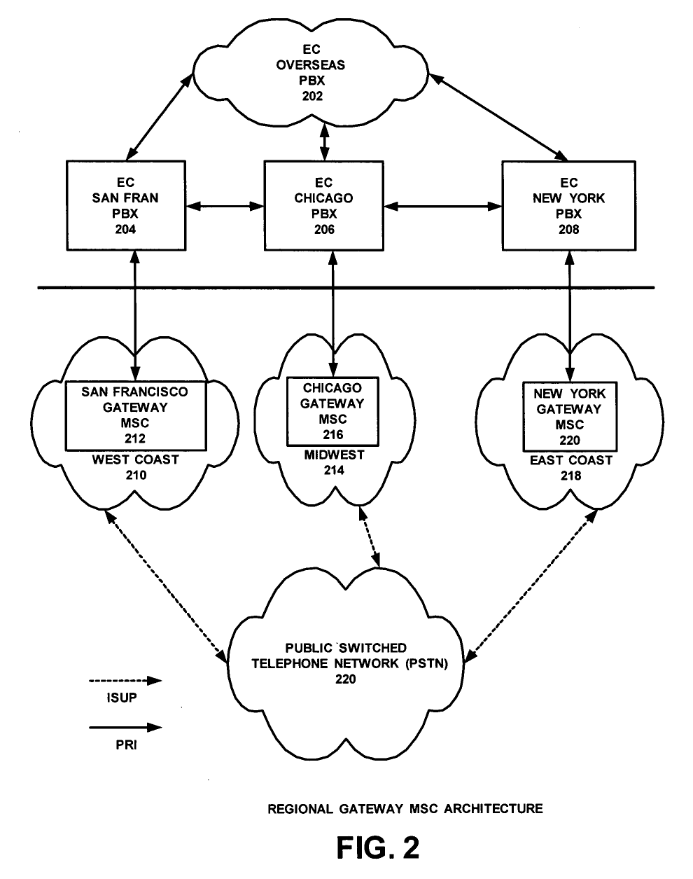

FIG. 1 is a representation of one implementation of a single gateway MSC architecture, and FIG. 2 is a representation of one implementation of a regional gateway MSC architecture.

The single gateway MSC architecture, depicted in FIG. 1, may have an EC OVERSEAS PBX 102 operatively coupled to a plurality of PBXs, such as, EC SAN FRAN PBX 104, EC CHICAGO PBX 106 and EC NEW YORK PBX 108. In this example, the EC NEW YORK PBX 108 is operatively coupled to a NEW YORK GATEWAY MSC 116 in an east coast region 114. A PSTN 118 may be operatively coupled to the east coast region 114, as well as, to west coast region 110 and midwest region 112.

The regional gateway MSC architecture, depicted in FIG. 2, may have an EC OVERSEAS PBX 202 operatively coupled to a plurality of PBXs, such as, EC SAN FRAN PBX 204, EC CHICAGO PBX 206 and EC NEW YORK PBX 208. In this example, the EC NEW YORK PBX 208 is operatively coupled to a NEW YORK GATEWAY MSC 220 in an east coast region 218, the EC CHICAGO PBX 206 is operatively coupled to a CHICAGO GATEWAY MSC 216 in a midwest region 214, and the EC SAN FRAN PBX 108 is operatively coupled to a SAN FRANCISCO GATEWAY MSC 212 in a west coast region 210. A PSTN 220 may be operatively coupled to the east coast region 218, as well as, to west coast region 210 and midwest region 214.

In each of the single and regional gateway MSC architectures the PSTN may be coupled to the various regions by ISUP, or by SIP and SIP-T for Internet protocols. SS7 ISDN User Part (ISUP) software provides the interface for applications to establish, maintain, and clear circuit switched connections via the SS7 network, in accordance with the CCITT Q.761-Q.764 and ANSI T1.113 (1988 and 1992) recommendations. The ISUP layer is also responsible for circuit management, such as blocking, unblocking, and resetting of circuits and circuit groups.

In each of the single and regional gateway MSC architectures the EC OVERSEAS PBX may be coupled to the various PBXs by PRI (primary rate interface).

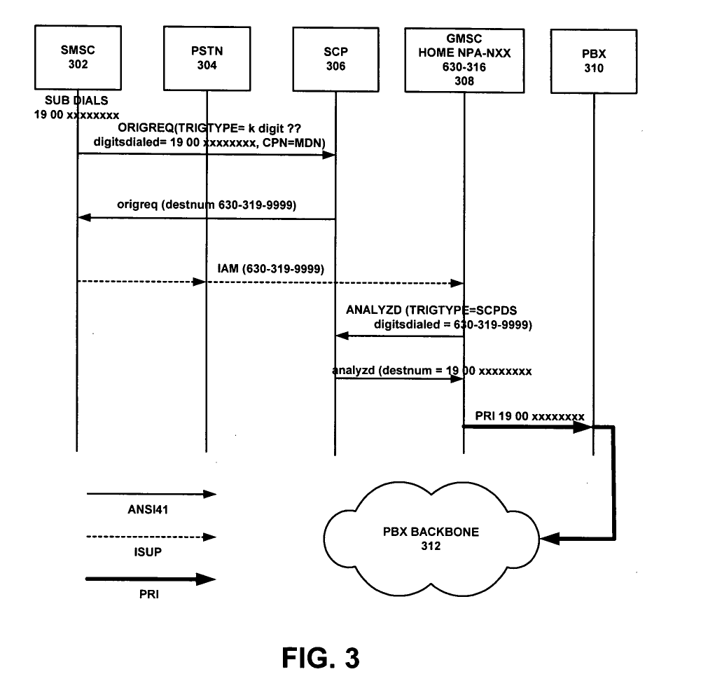

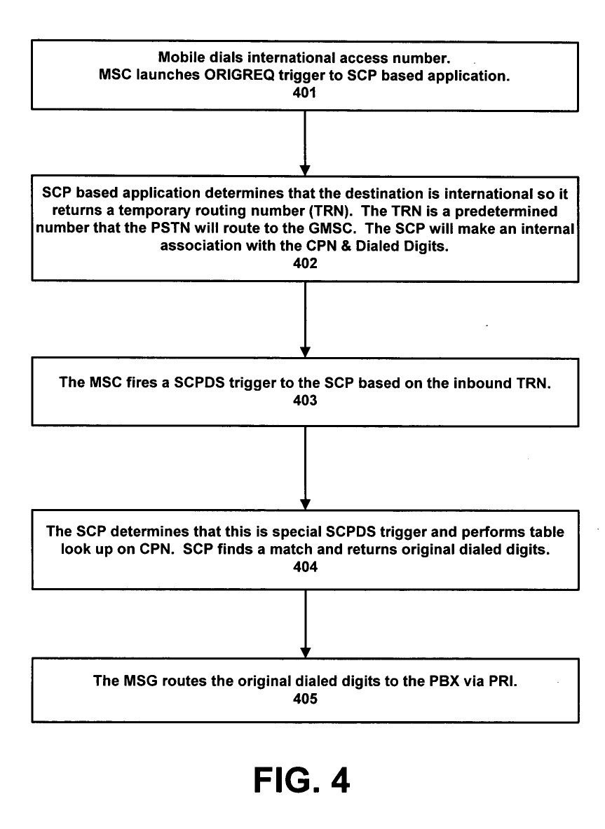

FIG. 3 is a representation of one exemplary flow diagram for integrating a private network with a mobility network; and FIG. 4 is another representation of one exemplary flow diagram for integrating a private network with a mobility network.

In these FIGS. 3 and 4 the serving MSC is referred to as SMSC and the gateway MSC is referred to as GMSC.

Referring now to FIG. 3 embodiments of the present method and apparatus utilize a wireless intelligent network (WIN) and a service control point (SCP) to intelligently route mobile originated calls destined for a private network, from the current serving MSC 302 to a designated gateway MSC 308. The designated gateway MSC308 may have direct connect trunking facilities to the enterprise customer's private network (PBX 310 and PBX backbone 312).

After receiving the call from the serving MSC 302, the gateway MSC 308 can then route the call directly to the private network. The private network can carry the call to its final destination within the private network (local, long distance, or international). Routing from the current serving MSC 302 to the designated gateway MSC 308 can be over dedicated facilities or via the PSTN 304.

From the MSC perspective, the serving MSC 302 supports some type of WIN triggers defined at an “Collected_Information” detection point as described in the WIN IS771 standard (e.g. all_calls, K-digit, etc.). It also requires the gateway MSC 308 to support the WIN trigger defined at an Analyzed_Information detection point, Specific_Called_Parry_Digit,_String (on incoming calls).

From the SCP 306 perspective, this solution requires the SCP 306 to support the receipt of triggers mentioned above along with application logic to redirect calls made by the subscriber in a serving MSC 302 to a gateway MSC 308 for final routing. The subscriber will dial a number destine for the private network 310 within the serving MSC 302. A WIN origination trigger (Orignation_Request_Invoke) will get sent to the SCP 306. The SCP 306 will determine that this call needs to be routed to a gateway MSC 308 that is connected to the subscriber's private network and return a Temporary Routing Number (TRN) to the serving MSC 302 (origination_request_return result). At the same time, the SCP 306 will make an entry into an internal table with the original digits dialed by the subscriber along with the subscribers Calling Party Number (CPN). The CPN is provided to the SCP 306 by the MSC within the Origination_Request_Invoke.

The serving MSC 302 will route the call via the TRN to the gateway MSC 308. The gateway 308 will have the WIN Specific_Called_Party_Digit_String (SCPDS) trigger armed on the incoming TRN. The gateway MSC 308 will send a WIN AnalyzedInformation message to the SCP 306. The SCP 306 will determine that a TRN was used to route this call and query its internal table with the CPN provided in the AnalyzedInformation message. The CPN will be found with the associated original dialed digits. The SCP 306 will provide the original dialed digits or a translation of the original dialed digits. The gateway MSC 308 will tandem the call to the private network 310 via dedicated facilities. The dedicated facilities can be ISUP or ISDN based. The private network routes the call as desired.

FIG. 4 depicts one embodiment of the present method. This embodiment may have the following steps:

Mobile terminal dials international access number. MSG launches ORIGREQ trigger to SCP based application. (401)

SCP based application determines that the destination is international so it returns a temporary routing number (TRN). The TRN is a predetermined number that the PSTN will route to the GMSC. The SCP will make an internal association with the CPN & Dialed Digits. (402)

The MSC fires a SCPDS trigger to the SCP based on the inbound TRN. (403)

The SCP based application determines that this is special SCPDS trigger and performs table look up on CPN. SCP finds a match and returns original dialed digits. (404)

The MSG routes the original dialed digits to the PBX via PRI. (405)

Embodiments of the present method and apparatus overcome the drawbacks of the prior art for intelligently routing mobile originated calls destined for a private network, from a current serving MSC to a designated gateway MSC.

The present apparatus in one example may comprise a plurality of components such as one or more of electronic components, hardware components, and computer software components. A number of such components may be combined or divided in the apparatus.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. A method comprising:
utilizing a WIN (wireless intelligent network) and a SCP (service control point) to intelligently route mobile originated calls destined for a private network, from current serving MSC (mobile switching center) to a designated gateway MSC.

2. The method according to claim 1, wherein the designated gateway MSC has direct connect trunking facilities to the private network.

3. The method according to claim 2, wherein, after receiving a call from the serving MSC, the gateway MSC routing the call directly to the private network.

4. The method according to claim 2, wherein the private network carries the call to a final destination within the private network (local, long distance, or international).

5. The method according to claim 1, wherein routing from the serving MSC to the designated gateway MSC occurs over one of dedicated facilities or via the PSTN.

6. The method according to claim 5, wherein the dedicated facilities are one of ISUP or ISDN based.

7. The method according to claim 1, wherein the serving MSC supports a predetermined type of WIN (wireless intelligent network) triggers.

8. The method according to claim 7, wherein the SCP supports receipt of the triggers along with application logic to redirect calls, made at the mobile terminal, in a serving MSC to a gateway MSC for final routing.

9. A method comprising:
dialing an access number from a mobile terminal, the access number being received by a serving MSC (mobile switching center);
launching a trigger from the serving MSC to an SCP based application;
determining, at the SCP based application, from the trigger that the destination is international and returning a TRN (temporary routing number) to the serving MSC;
sending the TRN from the serving MSC to a gateway MSC via a PSTN (public switched telephone network);
sending, from the serving MSC, a SPDS (specific party digit string) trigger to a SCP (service control point) in the gateway MSC;
determining, at the SCP, that the received SPDS trigger is a special SCPDS (specific called party digit string) trigger and performing a table look up on a CPN (calling party number), the SCP making an internal association with the CPN and dialed digits of the international access number; and
returning one of the original dialed digits or translated digits based on the original digits, when the SCP finds a match for the CPN;
routing, by the gateway MSC, the original dialed digits to a PBX (private branch exchange) via PRI (private network).

10. The method according to claim 9, wherein the designated gateway MSC has direct connect trunking facilities to the private network.

11. The method according to claim 10, wherein, after receiving a call from the serving MSC, the gateway MSC routing the call directly to the private network.

12. The method according to claim 10, wherein the private network carries the call to a final destination within the private network (local, long distance, or international).

13. The method according to claim 9, wherein routing from the serving MSC to the designated gateway MSC occurs over one of dedicated facilities or via the PSTN.

14. The method according to claim 13, wherein the dedicated facilities are one of ISUP or ISDN based.

15. The method according to claim 9, wherein the serving MSC supports a predetermined type of WIN (wireless intelligent network) triggers.

16. The method according to claim 15, wherein the SCP supports receipt of the triggers along with application logic to redirect calls, made at the mobile terminal, in a serving MSC to a gateway MSC for final routing.

17. An apparatus comprising:
a WIN (wireless intelligent network) operatively coupled to a SCP (service control point) to intelligently route mobile originated calls destined for a private network, from a current serving MSC (mobile switching center) to a designated gateway MSC.

18. The apparatus according to claim 17, wherein the designated gateway MSC has direct connect trunking facilities to the private network.

19. The apparatus according to claim 17, wherein routing from the serving MSC to the designated gateway MSC occurs over one of dedicated facilities or via the PSTN.

20. The method according to claim 17, wherein the dedicated facilities are one of ISUP or ISDN based.
